(19) United States
(12) Patent Application Publication
(10) Pub. No.: US 2008/0100502 A1
(43) Pub. Date: May 1, 2008

(54) Positioning apparatus

(75) Inventors: Joni JANTUNEN, Helsinki (FI); Kimmo KALLIOLA, Helsinki (FI); Jussi KAASINEN, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/974,511

(22) Filed: Oct. 12, 2007

(30) Foreign Application Priority Data
Oct. 12, 2006 (GB) 0620187.5

(51) Int. Cl. G01S 13/00

(52) U.S. Cl. 342/146

(57) ABSTRACT

An apparatus, computer program and a chipset for performing a method, the method, comprising: receiving, at a first position and in a first reference system, a first radio signal from a signal source; determining a direction of arrival, in the first reference system, of the received first radio signal; receiving, at a second position and in a second reference system, a second radio signal from a signal source; determining a direction of arrival, in the second reference system, of the received second radio signal; detecting a displacement between the first position and the second position; and determining a distance to the signal source, by using the direction of arrival in the first reference system of the first radio signal, the direction of arrival in the second reference system of the second radio signal and a displacement between the first position and the second position.

### BACKGROUND

1. Technical Field

Embodiments of the present invention relate to positioning apparatus. In particular, they relate to an apparatus, a method, a computer program, a chipset and a module for finding a distance relative to a signal source.

2. Discussion of Related Art

In many situations, it is desirable to determine the distance from one point to another, for example, to locate an object. It is possible to determine a distance between two points by using radio frequency (RF) waves. Previous proposals have involved using a first mobile RF device to transmit a signal to a second mobile RF device, which determines the distance between them by analyzing the attenuation that has occurred during the propagation of the signal. However, typically, the resulting calculation of the distance is subject to a large degree of error or requires processing capabilities that are inappropriate for mobile devices.

Other methods have used time-of-flight measurement, or clock synchronization and bi-directional data exchange to find the distance from one apparatus to another. However, accurate time-of-flight based methods require wide bandwidth and accurate compensation of device internal delays, which can be limiting factors. On the other hand, reducing the error to an acceptable level when using clock synchronization requires the use of very accurate clocks such as atomic clocks, which may be expensive. Implementations involving bi-directional data exchange tend to be complex because they require the active involvement of both of the RF devices and one of the RF devices cannot be merely a broadcasting beacon.

### SUMMARY

According to a first embodiment there is provided a method, comprising: receiving, at a first position and in a first reference system, a first radio signal from a signal source; determining a direction of arrival, in the first reference system, of the received first radio signal; receiving, at a second position and in a second reference system, a second radio signal from a signal source; determining a direction of arrival, in the second reference system, of the received second radio signal; detecting a displacement between the first position and the second position; and determining a distance to the signal source, by using the direction of arrival in the first reference system of the first radio signal, the direction of arrival in the second reference system of the second radio signal and a displacement between the first position and the second position.

According to a second embodiment there is provided an apparatus, comprising: a receiver arranged to receive a first radio signal from a signal source, when the apparatus is at a first position and has a first orientation, and arranged to receive a second radio signal from the signal source, when the apparatus is at a second position and has a second orientation; and processing circuitry arranged to determine a direction of arrival of the received first radio signal and to determine the direction of arrival of the received second radio signal; a detector arranged to detect a displacement between the first position and the second position; and wherein the processing circuitry is arranged to determine a distance to the signal source, by using the direction of arrival of the first radio signal, the direction of arrival of the second radio signal and a displacement between the first position and the second position.

According to a third embodiment there is provided a computer program, comprising: instructions for determining a direction of arrival, in a first reference system, of a first radio signal received at a first position from a signal source; instructions for determining a direction of arrival, in a second reference system, of a second radio signal received at a second position from a signal source; instructions for determining a distance to the signal source, using the direction of arrival in the first reference system of the first radio signal, the direction of arrival in the second reference system of the second radio signal and a displacement from the first position to the second position.

According to a fourth embodiment there is provided an apparatus, comprising: means for receiving a first radio signal from a signal source, when the apparatus is at a first position and has a first orientation, and for receiving a second radio signal from the signal source, when the apparatus is at a second position and has a second orientation; and means for determining a direction of arrival of the received first radio signal, and for determining the direction of arrival of the received second radio signal; means for detecting a displacement between the first position and the second position; and means for determining a distance to the signal source by using the direction of arrival of the first radio signal, the direction of arrival of the second radio signal and the displacement between the first position and the second position.

According to a fifth embodiment there is provided a chipset, comprising: circuitry arranged to determine a direction of arrival, in a first reference system, of a first radio signal received at a first position from a signal source; circuitry arranged to determine a direction of arrival, in a second reference system, of a second radio signal received at a second position from a signal source; and circuitry arranged to determine a distance to the signal source using the direction of arrival in the first reference system of the first radio signal, the direction of arrival in the second reference system of the second radio signal and a displacement from the first position to the second position.

According to a sixth embodiment, there is provided a module, comprising: circuitry arranged to determine a direction of arrival, in a first reference system, of a first radio signal received at a first position from a signal source; circuitry arranged to determine a direction of arrival, in a second reference system, of a second radio signal received at a second position from a signal source; and circuitry arranged to determine a distance to the signal source using the direction of arrival in the first reference system of the first radio signal, the direction of arrival in the second reference system of the second radio signal and a displacement from the first position to the second position.

### BRIEF DESCRIPTION OF THE DRAWINGS

For a better understanding, reference will now be made by way of example only to the accompanying drawings in which:

FIG. 1 illustrates an apparatus;

FIG. 2A illustrates a first direction determining antenna system;

FIG. 2B illustrates a second direction determining antenna system;

FIG. 3 illustrates a signal source transmitting radio signals to the apparatus, where the apparatus moves along a straight path;

FIG. 4 illustrates a method of determining a distance from the apparatus to the signal source; and

FIG. 5 illustrates a signal source transmitting radio signals to the apparatus, where the apparatus does not move along a straight path.

### DETAILED DESCRIPTION OF EMBODIMENTS

The Figures illustrate a method, comprising: receiving, at a first position 51 and in a first reference system 50, a first radio signal 103 from a signal source 20; determining a direction of arrival, in the first reference system 50, of the received first radio signal 103; receiving, at a second position 61 and in a second reference system 60, a second radio signal 104 from a signal source 20; determining a direction of arrival, in the second reference system 60, of the received second radio signal 104; detecting a displacement between the first position 51 and the second position 61; and determining a distance to the signal source 20, by using the direction of arrival, in the first reference system 50, of the first radio signal 103, the direction of arrival, in the second reference system 60, of the second radio signal 104 and a displacement between the first position 51 and the second position 61.

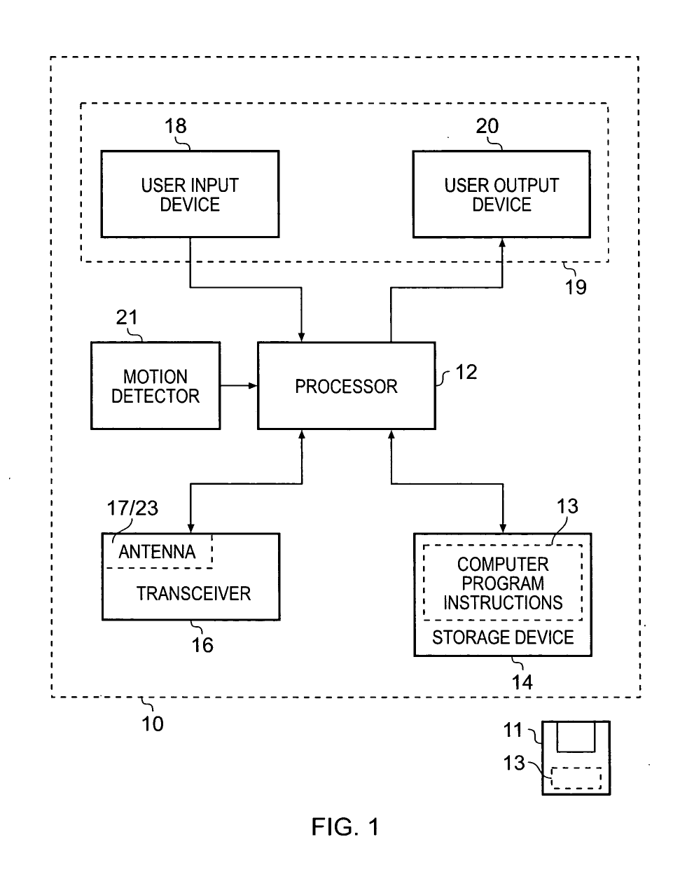

FIG. 1 is a schematic illustration of an apparatus 10. The apparatus 10 may be a hand portable electronic device. The apparatus 10 comprises a processor 12, a storage device 14, a transceiver 16, a user input device 18, a user output device 20 and a motion detector 21.

The processor 12 may be any type of processing circuitry. For example, the processor 12 may be a programmable processor that interprets computer program instructions 13 and processes data. Alternatively, the processor 12 may be, for example, programmable hardware with embedded firmware. The processor 12 may be a single integrated circuit or a set of integrated circuits (i.e. a chipset). The chipset may be incorporated within a module, which may be integrated within the apparatus 10, and/or may be separable from the apparatus 10. The processor 12 may also be a hardwired, application-specific integrated circuit (ASIC).

The processor 12 is connected to provide an output to the transceiver 16 and connected to receive an input from the transceiver 16. The transceiver 16 may be operable to transmit and receive radio frequency signals. The transceiver 16 comprises a direction determining antenna system 17/23.

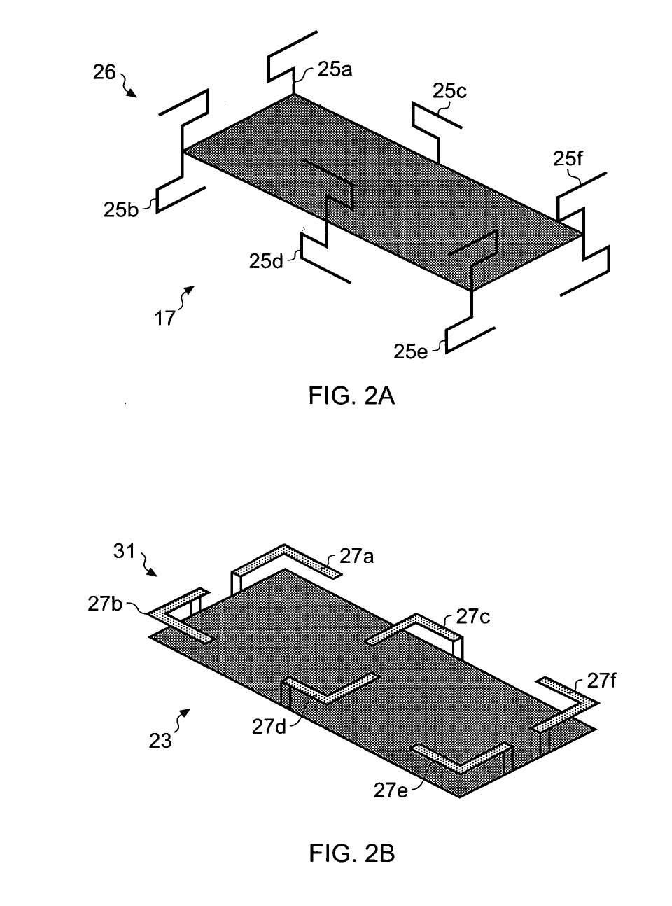

The direction determining antenna system 17/23 may comprise at least two antenna elements for determining the direction that a radio signal is received from by the transceiver 16. Examples of direction determining antenna systems 17/23 are illustrated in FIGS. 2A and 2B. It should be appreciated by the skilled person, however, that other direction determining antenna systems may be used in place of the illustrated antenna systems 17/23.

FIG. 2A illustrates a first direction determining antenna system 17 comprising antenna elements 25a to 25f. The antenna elements 25a to 25f form an antenna array 26. The first antenna system 17 is based upon meandered dipoles.

FIG. 2B illustrates a second direction determining antenna system 23 comprising antenna elements 27a to 27f. The antenna elements 27a to 27f form an antenna array 31. The second antenna system 23 is based upon based upon PIFAs (Planar Inverted F Antennas).

The direction of arrival of an incident radio signal may be resolved using a number of methods. In particular, the direction of arrival may be resolved using the phase and possibly also the difference in amplitude of a radio signal that is received by the individual elements of an antenna array.

In one method, historically known as the Bartlett Beamformer, the normalized received power in each array look direction (θ) is calculated using the following relationship:

$$P ( θ ) = \frac{{a}^{H} ( θ ) Ra ( θ )}{{L}^{2}}$$

In equation (1), a(θ) is a so called steering vector of the array and R is the spatial covariance matrix of the received signal. L is the number of elements in the antenna array. a^{H} denotes a conjugate transpose of the matrix a. The direction giving the highest power is then assumed to be the direction of the target.

The covariance matrix R is obtained as:
R=E{x(t)x^{H}(t)} (2)
where x(t) is the vector of signals received from the antenna elements as a function of time t.

The elements of the steering vector a(θ) are the output signals of the array elements, when it receives a plane wave from direction θ. It is defined as:
aₙ(θ)=gₙ(θ)·e^{-jkr}^{ₙ}^{*u}^{ᵣ}^{(θ)} (3)
in which gₙ(θ) is the complex radiation pattern of element n, k is the wave number (defined as 2π/λ where λ is the wavelength at center frequency), rₙ is the location vector of element n, and uᵣ is the radial vector towards the incident wave direction θ. In a simple case of a linear array of identical and equally spaced elements the steering vector simplifies to:
a(θ)=g(θ)[1e^{-jkd cos θ} . . . e^{-j(L-1)kd cos θ}]^{T} (4)
in which d is the inter-element spacing of linear, equally spaced antenna elements in the array. θ is the angle between the line connecting the linearly located antenna elements and the incident wave direction.

In a portable electronic device, the radiation patterns of the elements are typically not identical because they are affected by the metallic chassis of the device. The elements may also be differently oriented due to space limitations in the device. In this case, either Equation (3) must be used, or the steering vector can also be directly measured in a calibration measurement, or it can be computed using electromagnetic simulation tools.

The radio frequency signals that the transceiver 16 is operable to transmit and receive may be “low power” signals, such as those formulated according to the Bluetooth specification or the forthcoming Wibree specification. Further information regarding Wibree technology (formerly known as the Bluetooth Low End Extension) is described in Mauri Honkanen et al., “Low End Extension for Bluetooth” IEEE Radio and Wireless Conference RAWCON 2004, Atlanta, Ga., September, 2004, pages 19-22.’ The radio frequency signals may also be formulated according to specifications relating to UWB or Zigbee technologies.

For example, low power radio frequency signals may have a transmission range of 100 meters or less. Some low power radio frequency signals may have a transmission range of 10 meters or less.

The processor 12 is connected to receive an input from the user input device 18. The user input device 18 receives input from a user and may, for example, comprise a keypad and/or an audio input. The processor 12 is also connected to provide an output to the user output device 20. The user output device 20 is for conveying information to a user and may, for example, comprise a display or an audio output. The user input device 18 and the user output device 20 together form a user interface 19. It may be that the user input device 18 and the user output device 20 are provided as a single unit, such as a touch sensitive display device.

The processor 12 is connected to receive an input from the motion detector 21. The motion detector 21 may be, for example, a three dimensional accelerometer configured to detect translation of the apparatus in any direction. The motion detector 21 may, for example, also comprise a magnetometer and/or a gyrometer for detecting rotation of the apparatus 10.

The processor 12 is connected to read from and write to the storage device 14. The storage device 14 is, in this example, operable to store computer program instructions 13, and may be a single memory unit or a plurality of memory units. If the storage device 14 comprises a plurality of memory units, part or the whole of the computer program instructions 13 may be stored in the same or different memory units.

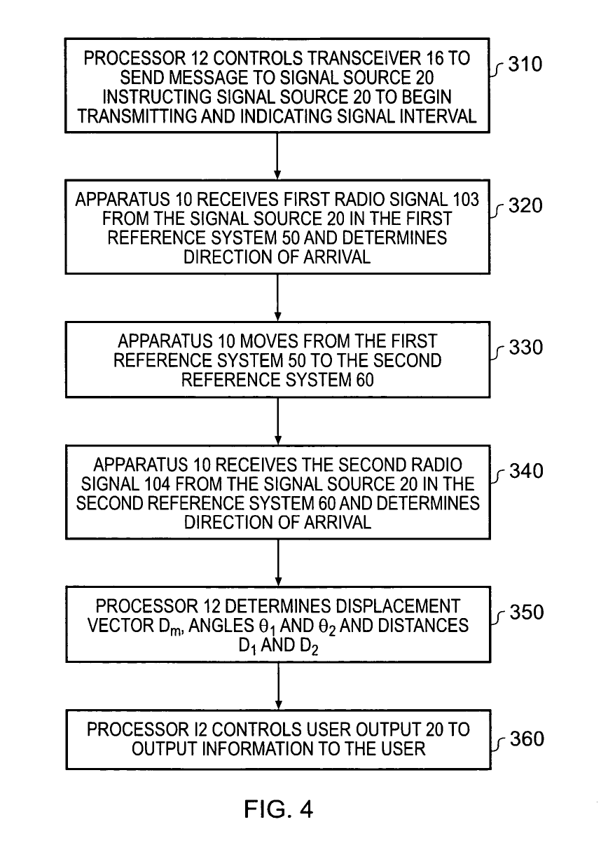

The computer program instructions 13 stored in the storage device 14 control the operation of the apparatus 10 when loaded into the processor 12. The computer program instructions 13 provide the logic and routines that enable the apparatus 10 to perform the method illustrated in FIG. 4 and described below.

The computer program instructions 13 provide: instructions for determining a direction of arrival of a first radio signal 103, received from a signal source 20, at a first position 51 and in a first reference system 50; instructions for determining a direction of arrival of a second radio signal 104, received from a signal source 20, at a second position 61 and in a second reference system 60; instructions for determining a distance to the signal source 20, using the direction of arrival of the first radio signal 103, the direction of arrival of the second radio signal 104 and a displacement from the first position 51 to the second position 61.

The computer program instructions may arrive at the apparatus 10 via an electromagnetic carrier signal or be copied from a physical entity 11 such as a computer program product, a memory device or a record medium such as a CD-ROM or DVD.

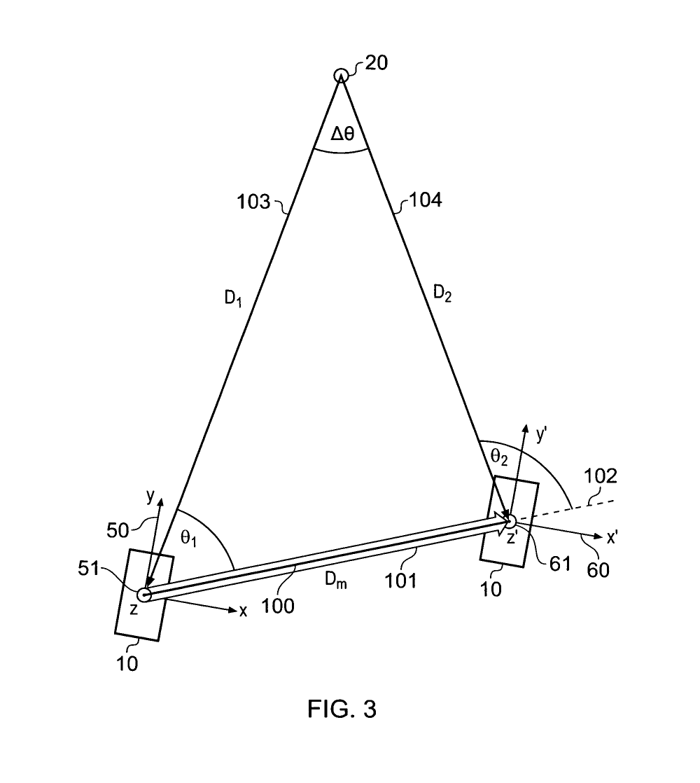

FIG. 3 illustrates a plan view of a system including a signal source/beacon 20 transmitting radio frequency signals 103, 104 to the apparatus 10. The signal source 20 comprises a transmitter for transmitting a first radio frequency signal 103 to the apparatus 10 when the apparatus 10 is in a first position 51, and for transmitting a second radio frequency signal 104 to the apparatus 10 when the apparatus 10 is in a second position 61. The first and second radio frequency signals 103, 104 may be advertisement packets defined in the specification relating to Wibree.

The signal source 20 may comprise a receiver arranged to receive radio frequency signals from the apparatus 10. The signal source 20 may be a hand portable electronic device and may be of the same form as the apparatus 10 described in relation to FIG. 1.

It may be that the signal source 20 is mobile, and represents an object that the user of the apparatus 10 wishes to find. For example, the signal source 20 may be contained in a mobile object such as a ball (e.g. a golf ball), or it may be comprised in a wearable object (e.g. to be worn by a child or an animal). However, in the method described below, the signal source 20 is considered to be substantially stationary or moving very slowly when transmitting the first and second radio signals 103, 104 to the apparatus 10.

FIG. 4 illustrates a method according to an embodiment of the invention. In this embodiment, at step 310 in FIG. 4, following user control of the user input device 18, the processor 12 receives an input from the user input device 18. The processor 12 interprets the input and controls the transceiver 16 to transmit a message to the signal source 20. The message instructs the signal source 20 to begin transmitting radio signals to the apparatus 10. The message may also specify the interval of time between transmitted radio signals. For example, the time interval may be from 50 ms to several seconds.

In other embodiments of the invention, it is not necessary for the transceiver 16 to transmit a message instructing the signal source 20 to begin transmitting radio signals. For example, the signal source 20 may comprise a user input device, and it may be possible for a user to control the user input device to instruct the signal source 20 to begin transmitting radio signals.

At step 320, the transceiver 16 of the apparatus 10 receives the first radio signal 103 from the signal source 20 when in a first position 51. The first reference system 50 is dependent upon the orientation and the position of the apparatus 10. In the example illustrated in FIG. 3, the first reference system 50 comprises three orthogonal axes: the x, y and z axes. The x and y axes are, in this example, substantially parallel to the ground and substantially orthogonal to each other. The z axis is substantially orthogonal to the x and y axes and, in this example, is substantially perpendicular to the ground. The intersection of the x, y and z axes is fixed at a point within the volume of the apparatus 10, and defines the first position 51. The first reference system 50 defines the orientation and position of the apparatus 10 relative to all other objects.

Once the antenna 17/23 has received the first radio signal 103, the processor 12 determines, in the first reference system 50, the direction from which the first radio signal 103 is received, relative to the orientation of the apparatus 10.

At step 330, the apparatus 10 moves in a substantially straight line 100 from the first position 51 to a second position 61. The second position 61 is defined as the position of the apparatus 10 when the transceiver 16 receives a second radio signal 104 from the signal source 20.

In the second position 61, a second reference system 60 is defined. The second reference system 60 comprises three orthogonal axes (x′, y′ and z′). In the example illustrated in FIG. 3, the second reference system 60 is a translation of the first reference system 50. The axes x′, y′, z′ of the second reference system 60 are, in this example, substantially parallel to the axes x, y, z of the first reference system 50 (i.e. in moving from the first position to the second position, substantially no rotation of the apparatus 10 has occurred and the orientation of the apparatus 10 is substantially the same). The intersection of the x′, y′ and z′ axes is fixed at a point within the volume of the apparatus 10 and defines the second position 61.

The movement of the apparatus 10 from the first position 51 to the second position 61 is detected by the motion detector 21. Where the motion detector 21 is an accelerometer, the acceleration signal/vector measured by the accelerometer may be integrated twice with regard to time to produce a displacement vector Dₘ.

The displacement vector Dₘ represents the shortest, straight line distance from the first position 51 to the second position 61. In this example, the displacement vector Dₘ is aligned with the displacement 100 traveled by the apparatus 10.

At step 340, following the reception of the second radio signal 104, the apparatus 10 automatically (i.e. without user intervention) begins a process to calculate the distance from the second position 61 to the signal source 20 and from the first position 51 to the signal source 20.

Initially, the transceiver 16 receives the second radio signal 104 and the processor 12 determines the direction of arrival of the second radio signal 104 in the second reference system 60 (i.e. relative to the orientation of the apparatus 10 when it is in the second position).

At step 350, in response to the reception of the second radio signal 104, the processor 12 of the apparatus 10 integrates the acceleration vector produced by the accelerometer to determine the displacement vector Dₘ in the first reference system 50.

Once the direction of the displacement vector Dₘ in the first reference system 50 is known, the processor 12 determines a first angle θ₁, which is defined as the angle between the direction of arrival of the first radio signal 103 and the displacement vector Dₘ.

The dotted line 102 illustrated in FIG. 3 continues the displacement vector Dₘ beyond the second position, in the same direction as the displacement vector Dₘ. Following the determination of the first angle θ₁, the processor 12 determines a second angle θ₂, which is defined as the angle between the direction of arrival of the second radio signal 104 and the displacement vector Dₘ.

Once the displacement vector Dₘ, the first angle θ₁ and the second angle θ₂ are known, the processor 12 is operable to determine the distance D₁ from the first position 51 to the signal source 20 and the distance D₂ from the second position 61 to the signal source 20.

In order to determine the distances D₁ and D₂, firstly the processor 12 determines the angle Δθ between the direction of transmission of the first radio signal 103 from the signal source 20 and direction of transmission of the second radio signal 104 from the signal source 20 using the following formula:
Δθ=θ₂−θ₁ (5)

It can be shown that:
Dₘ sin θ₁=D₂ sin(Δθ) (6)

Therefore, processor 12 may determine the distance D₂ using the formula:

$${D}_{2} = {D}_{m} \frac{sin {θ}_{1}}{sin ( Δ θ )} \qquad ( 7 )$$

It may also be shown that:
D₁=Dₘ cos θ₁+D₂ cos(Δθ) (8)

Considering Equations (7) and (8), it can be shown that the processor 12 may determine the distance D₁ using the following formula:

$${D}_{1} = {D}_{m} [ cos {θ}_{1} + \frac{sin {θ}_{1}}{tan ( Δ θ )} ] \qquad ( 9 )$$

At step 360 of FIG. 4, the processor 12 controls the user output device 20 to output information to the user. In a situation where the user output 20 comprises a display, the processor 12 may control the display to display the distance from the second position 61 to the signal source 20 (i.e. distance D₂), as this is likely to represent the current distance that the apparatus 10 is away from the signal source 20. The processor 12 may control the display to display the distance from the first position 51 to the signal source 20. In both of these instances, the processor 12 may also control the display to display an indication of the direction in which the signal source 20 is situated (for example, using an arrow), enabling the user to orientate himself relative to the signal source 20.

Additionally or alternatively, the processor 12 may determine whether, following movement of the apparatus 10 from the first position 51 to the second position 61, the distance to the signal source 20 is reducing, by deducting distance D₂ from D₁, and then subsequently control the display to display this information.

Above, the first and second radio signals 103, 104 are described as being transmitted by the same source (the signal source 20). However, it is not necessary that the radio signals 103, 104 are transmitted from the same source. It may be sufficient for the radio signals 103, 104 to be transmitted from different signal sources if those signal sources are in close vicinity to each other.

Although the first and second radio signals 103, 104 are described above as being different signals, in practice they may be part of a continuous signal. Where the first and second radio signals 103, 104 are separate radio signals, they may not represent radio signals that are consecutively transmitted by the signal source 20 or consecutively received by the apparatus 10. For example, the determination of the distances D₁ and D₂ may be based upon the first and third radio signals that are received by the apparatus 10 (e.g. the second radio signal having been received when the apparatus 10 is in a position intermediate the first and second positions).

Alternatively or additionally, the apparatus 10 determine D₁ many times using different radio signals in order to reduce the error in D₁. For example, D₁ can be determined using the data associated with the first and second radio signals, the first and third radio signals, the first and fourth radio signals, and so on.

The apparatus 10 may also determine or estimate the error in the direction of arrival θ of radio signals. The apparatus 10 may place different weightings on the different direction of arrival measurements depending on the determined/estimated error. Additionally or alternatively, the apparatus 10 may choose not to use a direction of arrival measurement when the error in the signal is above a predetermined threshold value.

The location and orientation of the direction determining antenna system 17/23 in the apparatus may be such that a change in the orientation of the apparatus 10 would result in the apparatus 10 being able to make an improved estimation of one or both of the distances D₁ and D₂. In this situation, the processor 12 may control the user output device 20 to output instructions to the user for re-orientating the apparatus 10.

In one embodiment, the apparatus 10 comprises a receiver for receiving satellite positioning information and the storage device 14 is configured to store a map. In this embodiment, as the position of the apparatus 10 is known and the distance and direction of the signal source 20 relative to the apparatus 10 is known, the position of the apparatus 10 and position of the signal source 20 may be displayed on the map.

In the preceding paragraphs, the signal source 20 was described as being mobile, and as an object that it is desirable for the user of the apparatus 10 to find. However, in another embodiment, the signal source 20 may be used to locate the position of the apparatus 10 on a map, stored in the storage device 14. In this embodiment, as the location of the signal source 20 is known, the apparatus 10 may be positioned relative to the signal source 20. This embodiment of the invention may be useful, for example, for indoor navigation purposes. It may desirable (but is not necessary) to have two or more signal sources 20 for finding the position of the apparatus 10, in order to reduce the error in the positions found.

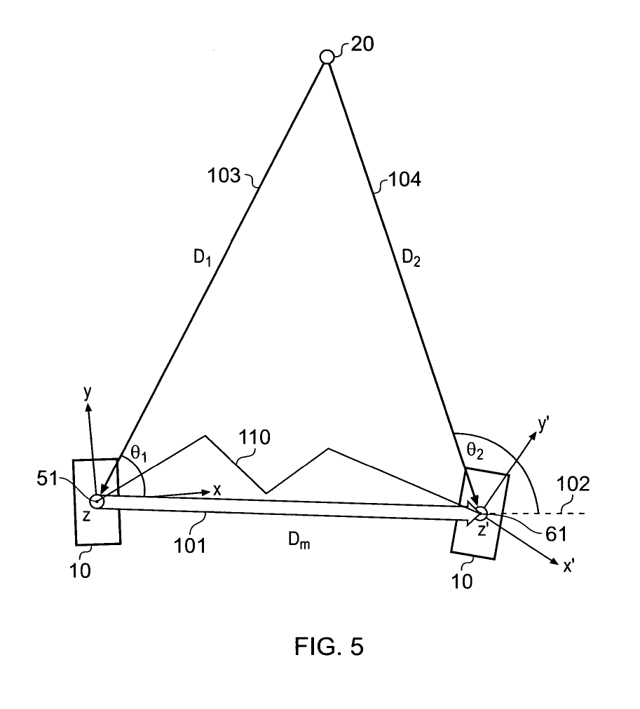

FIG. 5 illustrates a further embodiment of the invention in which the path 110 followed by the apparatus 10, in moving from the first reference system 50 to the second reference system 60, does not represent a straight line. The second reference system 60 represents a translation of the first reference system, and a rotation, in this example, about only the z axis.

In this embodiment, the motion detector 21 of the apparatus 10 also comprises a rotation sensor, such as a gyrosensor or a magnetometer. The rotation sensor detects the rotation of the apparatus 10 around at least the z axis, and may also detect the rotation of the apparatus 10 around the x and y axes.

The path 110 traveled by the apparatus 10 may be broken down into as series of vectors. Using a vector addition process, a resultant displacement vector Dₘ representing the overall movement between the first position 51 and second position 61 may be found. Furthermore, the relative rotation of the apparatus 10 in moving from the first reference system 50 to the second reference system 60 is known, as the rotation of the apparatus 10 is measured by the rotation sensor.

In this embodiment, the processor 12 may determine the first angle θ₁, between the direction of arrival of the first radio signal 103 and the resultant displacement vector Dₘ in the first reference system 50, because the direction of arrival and the direction of the displacement vector Dₘ in the first reference system 50 is known.

When the apparatus 10 is in the second position, processor 12 determines the direction of arrival of the second radio signal 104 in the second reference system 60. The relative rotation of the second reference system 60 compared to the first reference system 50 is known from the information provided from the rotation sensor. It is therefore possible to find the direction of the resultant displacement vector Dₘ in the second reference system 60, enabling the second angle θ₂, defined as that between the direction of arrival of the second radio signal 104 and the dotted line 102 that continues the resultant displacement vector Dₘ beyond the second position 61, to be found.

Although embodiments of the present invention have been described in the preceding paragraphs with reference to various examples, it should be appreciated that modifications to the examples given can be made without departing from the scope of the invention as claimed. For example, in the preceding embodiments, the motion detector 21 is described as being an accelerometer. The motion detector 21, however, may be anything that can detect movement of the apparatus 10 from the first position 51 to the second position 61. For instance, it may be a receiver for receiving satellite positioning information such as a GPS receiver. Alternatively, it may be possible to connect the apparatus 10 to a vehicle, and the odometer of the vehicle may provide the distance from the first position 51 to the second position 61. The vehicle may be, for example, a car, a bicycle or a shopping cart/trolley.

The signal source 20 is described above as being fixed or moving very slowly. In some embodiments of the invention, where the signal source 20 comprises or is linked to a motion detector, the radio signals 103 and 104 transmitted by the signal source 20 may comprise information regarding the movement of the signal source 20 that can be used in determining of distances D₁ and D₂ or to assess the confidence of distance computation in the apparatus 10.

In the embodiments described above, the processor 12 determines the direction of arrival of the radio signals 103, 104 using information supplied by the antenna system 17/23. However, it may be that the transceiver 16 includes its own dedicated processing circuitry for finding the direction of arrival of radio signals.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method, comprising:
receiving, at a first position and in a first reference system, a first radio signal from a signal source;
determining a direction of arrival, in the first reference system, of the received first radio signal;
receiving, at a second position and in a second reference system, a second radio signal from a signal source;
determining a direction of arrival, in the second reference system, of the received second radio signal;
detecting a displacement between the first position and the second position; and
determining a distance to the signal source, by using the direction of arrival in the first reference system of the first radio signal, the direction of arrival in the second reference system of the second radio signal and a displacement between the first position and the second position.

2. A method as claimed in claim 1, wherein the distance to the signal source is the distance between the second position and the signal source.

3. A method as claimed in claim 2, further comprising determining a distance between the first position and the signal source.

4. A method as claimed in claim 1, further comprising: transmitting a message to the signal source, instructing the apparatus to transmit radio signals.

5. A method as claimed in claim 1, further comprising: transmitting a message to the signal source, indicating a time interval that is to elapse between the transmission of the first and second radio signals.

6. A method as claimed in claim 1, further comprising: determining a displacement vector, representing movement from the first position to the second position.

7. A method as claimed in claim 1, wherein the displacement is detected by detecting motion between the first position and the second position.

8. A method as claimed in claim 7, wherein the motion is detected by detecting acceleration.

9. A method as claimed in claim 1, wherein the second reference system is substantially a translation of the first reference system.

10. A method as claimed in claim 1, wherein the second reference system is substantially a translation and a rotation of the first reference system.

11. An apparatus, comprising:
a receiver arranged to receive a first radio signal from a signal source, when the apparatus is at a first position and has a first orientation, and arranged to receive a second radio signal from the signal source, when the apparatus is at a second position and has a second orientation; and
processing circuitry arranged to determine a direction of arrival of the received first radio signal and to determine the direction of arrival of the received second radio signal;
a detector arranged to detect a displacement between the first position and the second position; and wherein
the processing circuitry is arranged to determine a distance to the signal source, by using the direction of arrival of the first radio signal, the direction of arrival of the second radio signal and a displacement between the first position and the second position.

12. An apparatus as claimed in claim 11, wherein the first orientation is the same as the second orientation.

13. An apparatus as claimed in claim 11, wherein the first orientation is different to the second orientation.

14. A computer readable medium having a computer program stored thereon, said computer program comprising coded instructions for determining a direction of arrival, in a first reference system, of a first radio signal received at a first position from a signal source;
instructions for determining a direction of arrival, in a second reference system, of a second radio signal received at a second position from a signal source; and
instructions for determining a distance to the signal source, using the direction of arrival in the first reference system of the first radio signal, the direction of arrival in the second reference system of the second radio signal and a displacement from the first position to the second position.

15. An apparatus, comprising:
means for receiving a first radio signal from a signal source, when the apparatus is at a first position and has a first orientation, and for receiving a second radio signal from the signal source, when the apparatus is at a second position and has a second orientation; and
means for determining a direction of arrival of the received first radio signal, and for determining the direction of arrival of the received second radio signal;
means for detecting a displacement between the first position and the second position; and
means for determining a distance to the signal source by using the direction of arrival of the first radio signal, the direction of arrival of the second radio signal and the displacement between the first position and the second position.

16. An apparatus as claimed in claim 15, wherein the second orientation is the same as the first orientation.

17. An apparatus as claimed in claim 15, wherein the second orientation is different to the first orientation.

18. A chipset, comprising:
circuitry arranged to determine a direction of arrival, in a first reference system, of a first radio signal received at a first position from a signal source;
circuitry arranged to determine a direction of arrival, in a second reference system, of a second radio signal received at a second position from a signal source; and
circuitry arranged to determine a distance to the signal source using the direction of arrival in the first reference system of the first radio signal, the direction of arrival in the second reference system of the second radio signal and a displacement from the first position to the second position.

21. A module, comprising:
circuitry arranged to determine a direction of arrival, in a first reference system, of a first radio signal received at a first position from a signal source;
circuitry arranged to determine a direction of arrival, in a second reference system, of a second radio signal received at a second position from a signal source; and
circuitry arranged to determine a distance to the signal source using the direction of arrival in the first reference system of the first radio signal, the direction of arrival in the second reference system of the second radio signal and a displacement from the first position to the second position.
